(19) United States
(12) Patent Application Publication
(10) Pub. No.: US 2020/0104962 A1
(43) Pub. Date: Apr. 2, 2020

(54) OPPORTUNISTIC PREFERENCE COLLECTION AND APPLICATION

(71) Applicant: Ford Global Technologies, LLC, Dearborn, MI (US)

(72) Inventors: Sudipto Aich, Palo Alto, CA (US); John Abernethy, Ingatestone (GB); Nitin Bandaru, Palo Alto, CA (US); Lisa Ratner, San Francisco, CA (US)

(73) Assignee: Ford Global Technologies, LLC, Dearborn, MI (US)

(21) Appl. No.: 16/585,205

(22) Filed: Sep. 27, 2019

Related U.S. Application Data
(60) Provisional application No. 62/738,280, filed on Sep. 28, 2018.

(51) Int. Cl. G06Q 50/30; G06Q 10/06

(52) U.S. Cl. CPC G06Q 50/30; G06F 16/23; G06Q 10/06315

(57) ABSTRACT

A provider, such as a transportation management service, can manage transport for a number of riders between various locations. A system can determine that a customer is in a vehicle, prompt the customer regarding the customer's preferences, and modify a trip characteristic based on the response. The customer can be a rider in a vehicle shared by other passengers such as in a ride sharing environment. The customer can request transit with a transit service; such a request may include at least one time component, such as a requested time of departure or arrival. A system can prompt the customer about the customer's preferences when the system determines that the customer is otherwise unoccupied. The system can use the responses to build a profile for the customer based on the responses. The system can then modify a vehicle characteristic and/or a route based on the profile and responses.

### RELATED APPLICATION

The present application claims priority to U.S. Provisional Patent Application No. 62/738,280, filed Sep. 28, 2018, and entitled “OPPORTUNISTIC PREFERENCE COLLECTION AND APPLICATION,” which is hereby incorporated by reference in its entirety as if fully set forth herein.

### FIELD OF THE DISCLOSURE

This disclosure generally relates to transportation services, and more particularly relates to systems and methods that allow a customer to personalize a ride in a vehicle of a transportation service.

### BACKGROUND

People are increasingly turning to a variety of different transportation and mobility offerings, including ridesharing in addition to conventional public transit offerings such as trains and public buses. When people share a ride with others, they sacrifice some of the customization that they would enjoy in private and personal transportation offerings. For example, if a person drives their own vehicle they may listen to a favorite radio program, drive with the windows down, or make detours for food. Such personal preferences are difficult to coordinate amongst riders in a ridesharing system.

### BRIEF DESCRIPTION OF THE DRAWINGS

Various embodiments in accordance with the present disclosure will be described with reference to the drawings, in which:

FIGS. 1A and 1B illustrate an example ride request environment in which aspects of various embodiments can be implemented;

FIG. 2 illustrates an example electronic device display for gathering customer preferences according to some embodiments;

FIG. 3 illustrates an example electronic device display for advising a customer about their destination according to some embodiments;

FIG. 4 illustrates an example electronic device display for a game amongst riders according to some embodiments;

FIG. 5 illustrates an example approach for matching ride requests to vehicle capacity that can be utilized in accordance with various embodiments;

FIGS. 6A and 6B illustrate example origination and destination locations, and routes for serving those locations, that can be determined for a service area over a period of time in accordance with various embodiments;

FIG. 7 illustrates an example system that can be utilized to implement aspect of the various embodiments;

FIG. 8 illustrates an example method for updating a customer profile according to various embodiments;

FIG. 9 illustrates an example technique for modifying a trip characteristic in response to receiving a customer's response;

FIG. 10 illustrates an example method for aligning passenger preferences according to some embodiments;

FIG. 11 illustrates an example method for automatically adjusting a trip characteristic according to various embodiments;

FIG. 12 illustrates an example computing device that can be utilized to submit trip requests and receive route options in accordance with various embodiments; and

FIG. 13 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to updating and utilizing customer profiles. In particular, various embodiments provide approaches for determining whether a customer is in a vehicle or will soon enter a vehicle, prompting the customer regarding the customer's preferences or thoughts. Various embodiments can provide approaches for modifying one or more characteristics of a vehicle, or a trip being provided by that vehicle, based at least in part upon the response, a set of aggregated responses, or a profile updated using the response. The customer can be a rider in a vehicle shared by other passengers such as in a ride sharing environment. The customer can request transit with a transit service; such a request may include at least one time component, such as a requested time of departure or arrival. A system can prompt the customer about the customer's preferences, such as when the system determines that the customer is otherwise unoccupied in some embodiments. The system can use the responses to build or update a profile for the customer based on the responses, or for the set of passengers currently in the vehicle, among other such options. The system can then modify one or more characteristics of the vehicle and/or route based on the profile and responses. The system can also, in some embodiments, provide information or content relating to the route, among other such options.

Various other such functions can be used as well within the scope of the various embodiments as would be apparent to one of ordinary skill in the art in light of the teachings and suggestions contained herein.

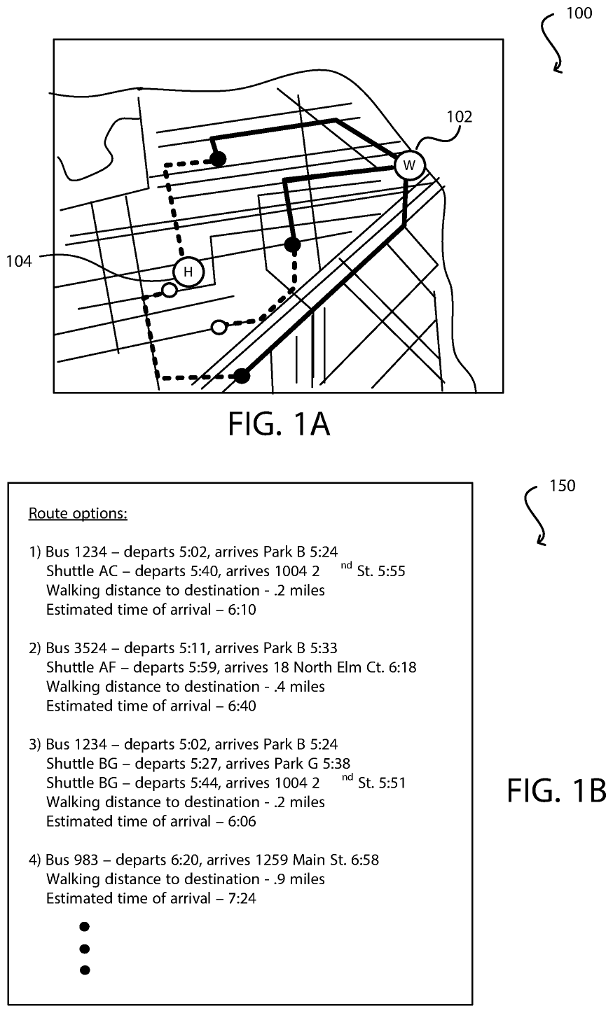

FIG. 1A illustrates an example location 100 in which aspects of the various embodiments can be implemented. In this example, a user can request transportation from an origin 102 to a destination location 104 using, for example, an application executing on a client computing device. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using one or more vehicles (or other modes of transportation) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. The rides provided to an individual rider from the point of departure to the point of arrival may also involve one or more vehicles, which may be of the same or different types, for the same or different modes of transportation. For example, in FIG. 1A a customer of a transportation service might want to use the service to obtain transport from a specified origin 102 or point of departure, such as the customer's place of employment, to a specified destination 104 or point of arrival, such as the user's home. Various other types of locations or ways of specifying locations can be used as well within the scope of the various embodiments. There may be modes of transportation offered that use fixed routes (such as trains or public buses), semi-fixed routes (such as shuttle buses), flexible routes (such as rideshares in passenger vehicles), or complete flexibility (such as e-bikes or scooters), among other such options. While more flexible options, such as ride shares, may provide for the shortest travel times in some situations, they may also come at a higher cost than fixed route options, such as subways or public buses. Further, flexible route options such as rideshares may be subject to traffic congestion or other issues that may introduce additional uncertainty into arrival times, etc.

For at least some of these reasons, customers or riders may choose to take fixed route transportation for at least some of their journey. For example, a customer might take a public bus out of downtown due to the relatively low cost and frequent availability of the buses. These buses can go to one or more stops from which the customer can obtain a connecting transport if needed, or desired, to complete a remainder of the journey. In many instances, a customer might want flexibility in the timing of the bus or initial mode of transport, such as to be able to catch the next available bus along a given route. A customer might also want to be able to select from multiple available routes to obtain additional options. As illustrated in FIG. 1A, there may be a number of bus routes (illustrated using the solid lines) that go from a destination, such as a bus stop near the customer's place of employment, to one or more destinations along substantially fixed routes. The customer may be willing to take any of these routes from the point of origin 102, particularly at rush hour or in inclement weather, etc.

In some embodiments discussed herein, a customer can view potential options for routes that involve multiple legs or segments, which may utilize one or more types of transportation. The customer can then select the option that is most desirable or of interest to them, or at least most closely satisfies the customer's current selection criteria, as may include timing and price, among other such options. An example presentation 150 of a set of options is illustrated in FIG. 1B. In this example, the customer is able to view a number of different options that satisfy, or otherwise at least partially match, one or more search criteria submitted by the customer for a future transportation need. As illustrated, the options can include different times of departure near the customer's requested time, that all leave from a specified location. The options include different options for the initial leg, here including different buses that travel at different times and/or to different locations. From those locations, there are different options presented to continue on towards the destination. These include not only different connection options, such as different shuttles, but also include options for walking or biking certain distances, etc. A user can select from among these options, and a transportation service or other entity system providing the options can cause corresponding reservations to be made for the selected options, such as for capacity on specific vehicles or routes as made through the corresponding transportation providers, which may include public entities or other third parties in at least some embodiments.

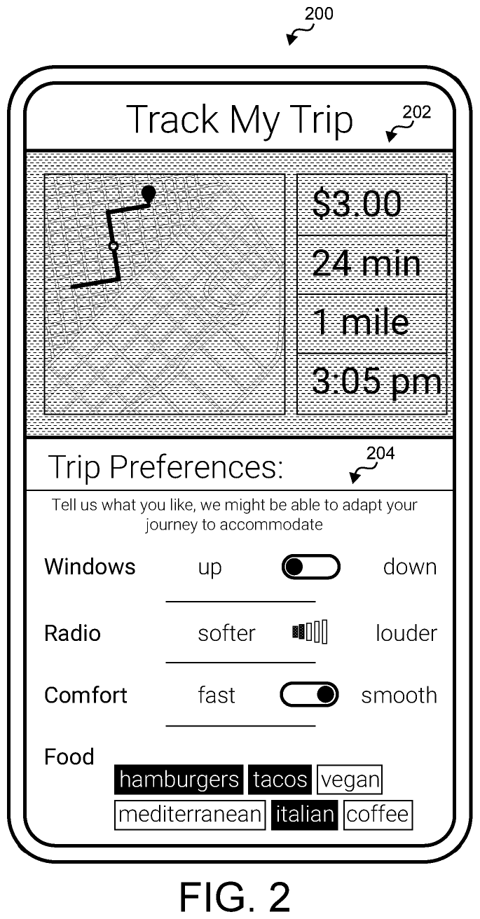

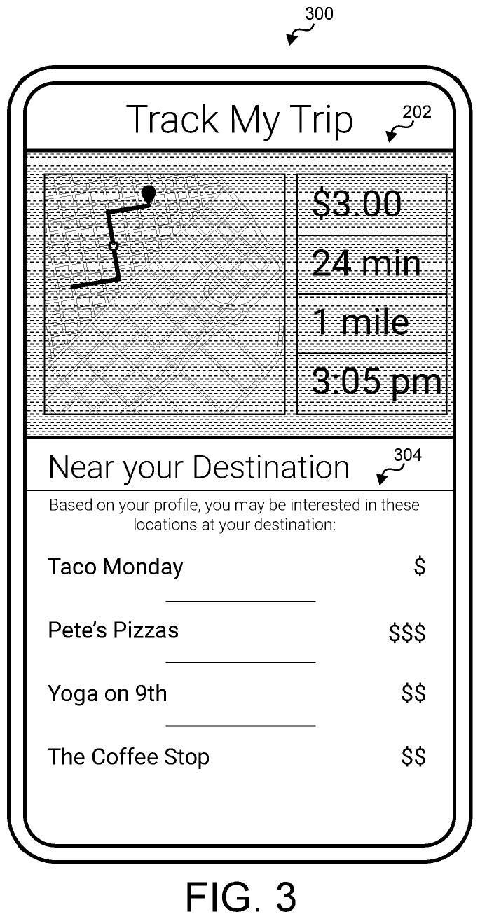

FIG. 2 illustrates an example electronic device display 200 according to some embodiments. Although a phone is depicted, other devices can be used. For example, an electronic device can be affixed to the vehicle that a rider can interact with. Such electronic devices can be embedded in the back of a headrest, dashboard, ceiling, etc. in the vehicle for individual or community access. Such an electronic device can be operable via voice, gesture, touch, tactile buttons, etc. Such an electronic device can have speakers, audio/video output ports, screens, etc. The example electronic device display 200 can be owned by the customer or associated with a seat of the customer. In some embodiments, the electronic device is connected to a communications network for a service that coordinates and/or provides rides for customers.

The example electronic device display 200 can present a status 202 of the current trip. This status can include the origin, the destination, the current location of the vehicle, the cost, the trip duration, the expected arrival at the destination, transfer information, etc. The status 202 can include current vehicle state information. For example, the status 202 can indicate the current cabin air temperature, humidity, artificial light status, ambient light status, window status, vehicle audio status, vehicle speed, etc. In some embodiments, the device display 200 can be associated with an application (or “app”) executable on a device.

The example electronic device display 200 can present a trip preferences prompt 204 for inquiring the preferences of the customer. In some embodiments, a customer might linger while reviewing the status 202 of the trip. For example, a customer might watch how the trip is progressing. The customer may become bored or otherwise unoccupied while reviewing the status of trip. A system can determine that the customer would be willing to answer questions about their trip preferences or preferences in general. For example, the customer can specify that the customer prefers certain atmospheric attributes.

The trip preferences prompt 204 can provide toggle prompts where a customer can indicate that they prefer one thing over the other (e.g., windows down versus windows up). A toggle prompt can allow the customer to choose between alternative options such as a fast ride or a smooth ride (e.g., “comfort” in FIG. 2). In some embodiments, a prompt can allow a customer to input text. For example, the customer can type out their favorite restaurants etc. In some embodiments, a prompt can allow the customer to input a degree or scale according to a preference, such as the volume of a sound system of a vehicle.

The trip preferences prompt 204 can pertain to characteristics of the particular ride, such as whether the customer wants the windows down or up at that moment. Other characteristics for the current ride include a type of media playing (e.g., a movie or music), a selection of media, a volume or brightness of media, an overhead light setting, a windows down/up preference, a preferred temperature, a preferred humidity, an artificial fragrance preference, a fan speed for internal air, etc.

The system can inquire to whether the customer wishes to make a detour stop (e.g., for food) and what type of food the customer would be interested in. In some embodiments, multiple customers can provide their input for determining a detour stop and a system can determine a consensus. In some embodiments, a repeated voting system can have multiple rounds to determine a winning preference.

A prompt similar to the trip preferences prompt 204 can pertain to the customer profile. For example, a customer can provide their biographical information such as their birth date, their gender, their occupation, etc. Such a prompt can also inquire about the customer's contact information (e.g., phone number or email address). Such a prompt can facilitate the customer connecting with associates in order to share their progress on a trip or to coordinate future rides.

FIG. 3 illustrates an example electronic device display 300 according to some embodiments. Similar to in FIG. 2, electronic device display 300 can include a status 202 of a current trip. Because the status 202 might only require a section of the display, the system can provide relevant information 304 to the customer. For example, relevant information can detail what restaurants the customer may be interested in at the destination of the trip. Relevant information can provide the weather forecast at the destination or popular stores or other establishments that the system determines that the customer would be interested in. If the system does not have enough information to make recommendations, it can request more information from the customer via prompts as shown in at least FIG. 2. In some embodiments, the relevant information 304 section can provide an opportunity for the customer to engage the businesses or topics presented. For example, the customer can order food, reserve a room (e.g., at a hotel), call a taxi (e.g., for another leg of their journey), etc.

In some embodiments, the relevant information 304 can be about the current location of the customer. For example, relevant information 304 can identify shops, businesses, points of interest, scenic views, etc. that the customer might be interested in as the customer passes such places. In some embodiments, the relevant information 304 can provide historical information related to landmarks and events that have happened as the customer passes such locations. In some embodiments, the relevant information 304 can be advertisements of items that might be of interest to the customer. These items can be determined based on the trip and/or the customer's response to a prompt. For example, the item can be sunscreen if the customer is going to a sunny location.

In some embodiments, the relevant information 304 can be an opportunity for a customer to present their preferences to the system. For example, the customer can rate how much they enjoy a certain restaurant or can rank the restaurants presented in order of preference. The system can then take this information and incorporate it into a customer profile. This information can help guide destination choices. For example, a system may be tasked with choosing optimal routes given certain customers. The system can then determine that, even though the customers wish to end up in a certain region (e.g., a certain building covering a city block), the system can determine which side of the building to have as the destination based on the customer's preferences.

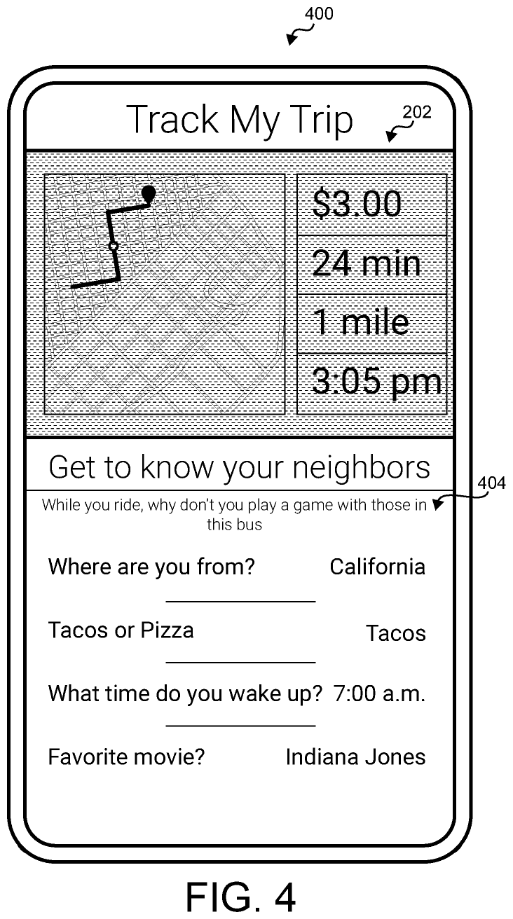

FIG. 4 illustrates an example electronic device display 400 according to some embodiments. Similar to in FIG. 2, electronic device display 400 can include a status 202 of a current trip. In some embodiments, electronic device display 400 can include a game section 404 where a customer can answer questions and then guess trivia about other passengers. For example, the customer can input their home town or state, their food preferences, their schedule, their profession, their favorite music, movies, etc., and other preferences of interest. After multiple people in a vehicle answer these questions, they can be presented with prompts where they can guess the statistics for the vehicle as a whole. For example, they can guess how many people are from California, or what percentage likes pizza over tacos. This can provide a fun and interactive way for a customer to pass the time and possibly be introduced to some other riders.

In some embodiments, the responses retrieved in the game section 404 can be used to inform a profile of the customer and determine the customer's preferences for the purposes of recommending content or itineraries that the customer would enjoy. With the customer's permission, the system can store this data and use it for purposes from which the customer would benefit.

As with single ride preferences, there can be customer preferences determined for selecting transportation for journeys requiring multiple segments. For example, a customer might prefer the shortest overall time duration regardless of the number of connections or modes of operation used. Others might prefer comfort, shortest connection times, or minimum number of connections, among others. For some customer, the preferences may vary by direction. For example, a customer might want to take only enclosed vehicles on the way to work, but may be more willing to walk or bike on the way home. Certain customers may also have preferred or required stop locations, or can specify locations or modes of transportation that are not to be used. A customer can also specify specific segments, vehicles, routes, or other aspects that are preferred, required, or not to be selected, etc. Various other options can be specified, such as maximum use of highway versus neighborhood driving, minimum or maximum pricing, minimum or maximum quality of service, etc. Any or all of these and other factors or preferences can be used with a routing selection and/or optimization function or process as discussed and suggested herein. Further, as mentioned at least some of these preferences can be learned for a customer over time.

In some embodiments an entire journey can be automatically booked or suggested to a customer. For example, a customer might leave from work at the same time on most weekdays. Accordingly, the service could send a notification to the customer as discussed above, but this notification instead could ask the user to confirm booking on the initial segment of the journey. This might be the same transportation option that the customer usually takes, or can be one of the options that are appropriate for the time and location. The user can confirm, select an option, decline, or specify new criteria for this particular time, such as an updated departure time or location. Various other options can be used as well within the scope of the various embodiments. In such a situation, the customer might have to confirm the selections for the subsequent segments of the journey, or the initial confirmation may enable the system to automatically book transport for each segment at a time appropriate based on any factors, or combinations thereof, discussed herein.

In some embodiments, the automatic booking may require the customer to take different actions as well. For example, the customer might be on a train or bus that makes multiple stops. In some embodiments, the transportation options for the next segment may depart from different stops or stations, such that the customer may need to be notified of the appropriate stop at which to catch the connection. If this is to be different from the typical or standard stop for that customer, or is anything other than the last stop, then the customer may need to confirm that the customer has received the instruction and will get off at the appropriate stop. In some embodiments the next segment can be automatically confirmed in response to the customer getting off at that stop, which can be detected by sensor, location, or other approaches such as those discussed and suggested herein Similarly, the customer can be notified if a better option would require the customer to stay on the current mode of transportation longer and instead get off at a later stop, etc. In some embodiments an application can also have an option where the user can indicate that the user would like to get off at a different stop, get to the destination sooner, or otherwise modify one or more segments. The service can then take this information and determine the best booking option based on the current location and desire of the customer.

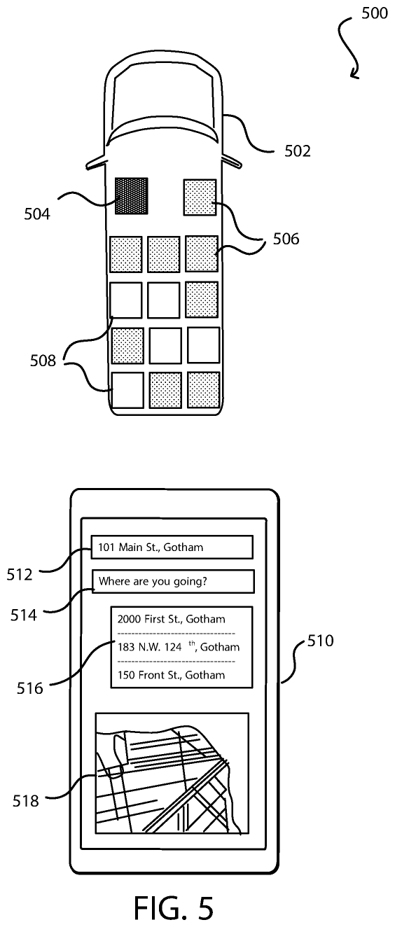

Various systems and services can be used to implement aspects of the invention as discussed and suggested herein. A transport service that provides vehicles that can concurrently be used by more than one rider is often referred to as a “rideshare” service, although as discussed vehicles such as bikes and scooters can be utilized as well which may only serve one customer at a time in at least some embodiments. In one example, a rideshare service can offer routes using at least one type of vehicle 502 that includes space 504 for a driver and seats or other capacity for up to a maximum number of riders, as illustrated in the example configuration 500 of FIG. 5. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 506 (or other rider locations) may be occupied by riders, while another number of seats 508 may be unoccupied. In some embodiments objects such as packages or deliveries may also occupy available space for a ride as well, which can include areas for seating or cargo, or convertible space, among other such options. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

A user can request transportation from an origination to a destination location using, for example, an application executing on a client computing device 510. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 502 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space 504 for a driver and seats or other capacity for up to a maximum number of riders. It should be understood that various types of vehicles can be used with different numbers or configurations of capacity, and that autonomous vehicles without dedicated drivers can be utilized as well within the scope of the various embodiments. In order to improve or maximize the economics of the rides offered, it can be desirable in at least some embodiments to have the occupancy or utilization as close to full as possible during the entire length of the trip. Such a situation results in very few unsold seats, or little unsold capacity, which improves operational efficiency. One way to achieve high occupancy might be to offer only fixed routes where all passengers board at a fixed origination location and off-board at a fixed destination location, with no passengers onboarding or off-boarding at intermediate locations. As mentioned, such an approach may be beneficial for at least one segment of a given customer journey.

In the present example, a given user can enter an origination location 512 and a destination location 514, either manually or from a set of suggested locations 516, among other such options, such as by selecting from a map 518 or other interface element. In other embodiments, a source such as a machine learning algorithm (or trained neural network, etc.) or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

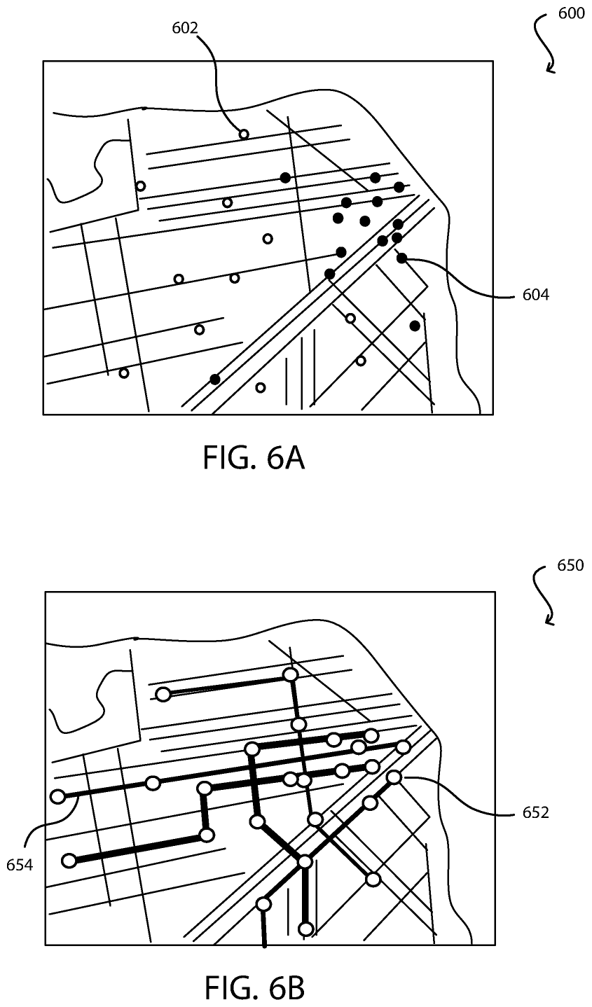

FIGS. 6A and 6B illustrate one example approach that can be utilized to provide such service in accordance with various embodiments. In the example mapping 600 of FIG. 6A, a set of origination points 602 and destination points 604 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the mapping 650 of FIG. 6B illustrates a selection of routes 652 that can be provided over a period of time in order to satisfy various rider requests. The routes may not include or correspond to each precise origination and destination location, but can come within an acceptable distance of those locations in most instances. Each route can also be served by one or more vehicles or modes of transportation, each servicing a portion or segment of a given route. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 652 provided by such a service may change over time, or even at different times of day, but can have at least a subset of segments that are sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for a vehicle routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the vehicle routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the vehicle routing system to focus on a part of the service window that can still be impacted, typically going forward in time. For prorated and planned but not yet driven routes, the optimal distance may be difficult to assess directly since the route is not actually being driven. To approximate the optimal distance not yet driven, the vehicle routing system can prorate the total optimal distance in some embodiments to represent a portion of the planned distance not yet driven.

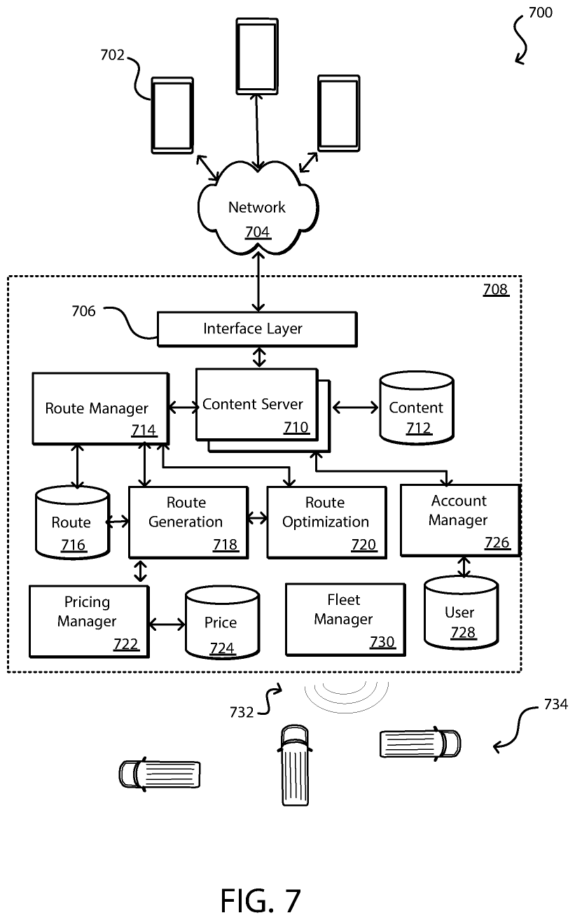

As mentioned, a route optimization system in some embodiments can attempt to utilize such an objective function in order to determine and compare various routing options. FIG. 7 illustrates an example system 700 that can be utilized to determine and manage vehicle routing in accordance with various embodiments. In this system, various users can use applications executing on various types of computing devices 702 to submit route requests over at least one network 704 to be received by an interface layer 706 of a service provider environment 708. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a Wi-Fi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 712 or other such location.

Information for the request can be directed to a route manager 714, such as may include code executing on one or more computing resources, configured to manage aspects of routes to be provided using various vehicles of a vehicle pool or fleet associated with the transport service. The route manager can analyze information for the request, determine available planned routes from a route data store 716 that have capacity can match the criteria of the request, and can provide one or more options back to the corresponding device 702 for selection by the potential rider. The appropriate routes to suggest can be based upon various factors, such as proximity to the origination and destination locations of the request, availability within a determined time window, and the like. In some embodiments, an application on a client device 702 may instead present the available options from which a user can select, and the request can instead involve obtaining a seat for a specific planned route at a particular planned time. As mentioned, in some embodiments the bookings or selections can be made by the route manager automatically based on various criteria, among other such options.

As mentioned, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 714 can receive several such requests, and can attempt to determine the best selection of routes to satisfy the various requests. In this example the route manager can work with a route generation module 718 that can take the inputs from the various requests and provide a set of route options that can satisfy those requests. This can include options with different numbers of vehicles, different vehicle selections or placements, different modes of transportation, different segment options, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 722 can determine the cost for a specific request using pricing data and guidelines from a price repository 724, which the user can then accept or reject.

In this example, the route generation module 718 can generate a set of routing options based on the received requests for a specified area over a specified period of time. A route optimization module 720 can perform an optimization process using the provided routing options to determine an appropriate set of routes to provide in response to the various requests. Such an optimization can be performed for each received request, in a dynamic vehicle routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 720 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

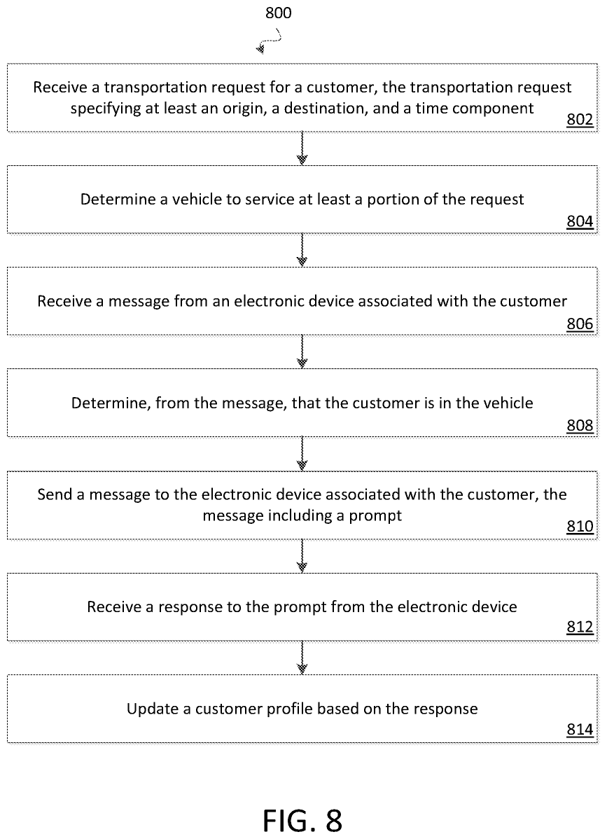

FIG. 8 illustrates an example method 800 for updating a customer profile according to various embodiments. Example method 800 can begin and receive a transportation request from a customer, the transportation request specifying at least an origin, a destination, and a time component 802. An application running on a portable electronic device can be used to generate the request using input from the customer. In some embodiments, a third party can submit the request on behalf of the customer. The third party can be a human agent of the customer or an automated service such as a digital assistant. The transportation request can include an origin region, an origin, address, an origin stop, etc. The transportation request can include a destination region, address, stop, etc. The time component can be a departure time, an arrival time, a trip time, etc. The trip request can include authorization for payment, a payment method, a maximum trip cost, etc. In some embodiments, the trip request is for a single trip while in other embodiments the trip request is for a sequence of trips (e.g., a commuter schedule).

The transportation request can be for transportation using car, taxi, and/or public transit such as bus, light-rail, train, ferry, etc. The system receiving the transportation request can be associated with a transportation service. In some embodiments, the system receiving the transportation request is not a provider of transportation but a facilitator, connecting transportation providers with customers and arranging rides.

The system can determine a type of vehicle to service at least a portion of the request 804. The system may then assign a vehicle that is suitable for the customer. For example, the system can determine that a bus route or train line can satisfy a portion of the request by the customer. In some embodiments, multiple modes of transportation can satisfy various portions of the request. For example, the system can determine that the customer can walk two blocks, catch a bus for a mile, and then take a taxi for the remainder of their journey. In some embodiments, the system can determine requisite transfers and ensure that, given anticipated variances, the transfers are met. In some embodiments, the system can determine a route for the customer to take. One route might have multiple vehicles servicing the route, perhaps at different times. The system can determine the optimal vehicle for the customer.

In some embodiments, the system can be in communication with a location system (e.g., GPS) installed in each vehicle. Should a vehicle deviate from an intended schedule, the system can adjust and, if necessary, change which vehicle a customer is assigned to. In some embodiments, a customer can be assigned to a specific seat of a vehicle. For example, a customer may be assigned a seat based on the length of the trip for a customer (those with short trips can be placed by an exit). In some embodiments, the vehicle and/or seat assignment can be based on a profile characteristic for the customer. For example, if the customer is of a certain status with the transportation system, the customer can receive preferential treatment. In some embodiments, the seat assignment can be based on interpersonal preferences for a customer. For example, a customer might prefer to sit next to another rider who shares the same desire to be quiet or to talk during a trip.

The system can receive a message from an electronic device associated with the customer 806. The message can represent that the customer has connected to a network, that the customer has reached a location, that the customer has used their electronic device to pay for passage, etc. In some embodiments, the electronic device can be a portable electronic device (e.g., a cell phone, tablet, watch, etc.) for the customer. In some embodiments, the electronic device is not owned by the customer, but is assigned to the customer at the vehicle. For example, the electronic device can be an entertainment center of a car, a seatback entertainment system, etc. In some embodiments, the customer is given an electronic device to borrow when the customer enters the vehicle. The electronic device can have a screen, a speaker, network connectivity, etc. as disclosed herein. In some embodiments, the customer logs in to the electronic device to connect to a profile on the system associated with the customer.

The system can determine from the message that the customer is in the vehicle 808. For example, the message can indicate a location for the electronic device. The system can then determine the location of the vehicle and, if there is a correspondence between the location of the vehicle and the location identified in the message, the system can determine that the customer is in the vehicle. In some embodiments, the message can be a ticketing message indicating that the customer paid for passage in the vehicle or presented a ticket at the vehicle. This information can indicate that the customer is at the vehicle.

The system can send a message to the electronic device associated with the customer, the message including a prompt 810. In some embodiments, upon determining that the customer is in the vehicle, the system can assume the customer is not otherwise engaged in activities. The customer may be unoccupied or bored. The system can receive a message indicating the customer's state beyond just that the customer is inside the vehicle. For example, the system can determine that the customer has opened a trip tracker application and is reviewing the status of the trip. The system, after a period of time of the application being active, can determine that the customer would not be opposed to answering prompts.

The prompt can regard the customer's preferences or biographical information and can be used to build or update a profile for the customer. Such information can include a username, email address, phone number, home address, work address, addresses of friends and family, contact information of associates (e.g., associates' usernames), the customer's birthdate, a payment method, authorization for payment, height and width (e.g., for choosing an appropriate seat), etc. In some embodiments, the prompt can be related to food preferences for the customer such as favorite restaurants, types of food, food orders, time of date to eat, etc. In some embodiments, the prompt can be related to media preferences for the customer such as whether the customer likes to listen to music, watch movies, read the news, browse social media sites, etc. while in transit. The prompt can pertain to what types of media the customer prefers. The prompt can pertain to environmental preferences for the customer such as a preferred cabin temperature, humidity settings, and fan speed. The prompt can pertain to whether the customer enjoys having the windows open. The prompt can pertain to whether the customer enjoys talking on the phone or doing other noticeable behavior during a trip; similarly the prompt can pertain to whether the customer enjoys, tolerates, or is adverse to such behavior in others.

In some embodiments, the prompt can pertain to a specific condition of the current trip. For example, the customer can indicate that the customer wishes to take a route that incurs a toll (paid at least in part by the customer) instead of a more circuitous route that does not incur the toll. Other prompts related to the current trip include a desire to take a restroom or food break, a speed up or slow down (e.g., if the customer is feeling unwell and the road has curves, the customer might prefer a slower speed).

In some embodiments, the electronic device can detect when the customer would not be bothered by the prompt. The system can take action to prevent interrupting or otherwise annoying the customer which may occur when providing prompts at inopportune moments. For example, if the customer is watching the status of their trip, a window can appear alongside the status that provides the queries in an unobtrusive manner. In some embodiments, the prompts are provided as a separate process, window, or module than such a trip status indicator. A prompt can be a notification, pop-up, text message (SMS, MMS, or proprietary chat systems), etc.

The system can receive a response to the prompt from the electronic device 812. For example, the system can receive a response via the Internet or some other communication medium. In some embodiments, a vehicle can have communication means that can interact with the electronic device. For example, a camera in the vehicle can read a QR code on a display for the electronic device, the QR code representing a response. In some embodiments, a customer can receive the prompt via one means and respond via another. For example, the customer can raise their hand, vocalize some expressions, etc.

The response can include identifiers of the electronic device used to make the response, the customer, the vehicle, etc. The response can include location information, profile information, etc. The response can include a string, rating, Boolean value, etc. In some embodiments, the response is sent to a different system than the system that generated the prompt. In some embodiments, the electronic device can send responses immediately while in other embodiments, the electronic device can hold on to responses until an opportune time to send them. For example, if there is insufficient network availability, the electronic device can wait until there is sufficient connectivity and can send the response at that time.

A system can update a customer profile based on the response 814. For example, the customer might have a profile with the transportation service and/or the system that received the response. Such a profile might be created by the customer or can be a backend profile that monitors the customer's preferences without the customer needing to create a profile. In some embodiments, a characteristic of the profile is changed to be a value in the response. Alternatively, the profile can update a value based on the response. For example, if the profile keeps track of the customer's overall preference for a certain type of food and the customer indicates that for the current trip the customer prefers Italian food, the system can increase a weighting of Italian food for the customer's profile (anticipating that the customer can have different preferences over time and the profile should not be dominated by one response).

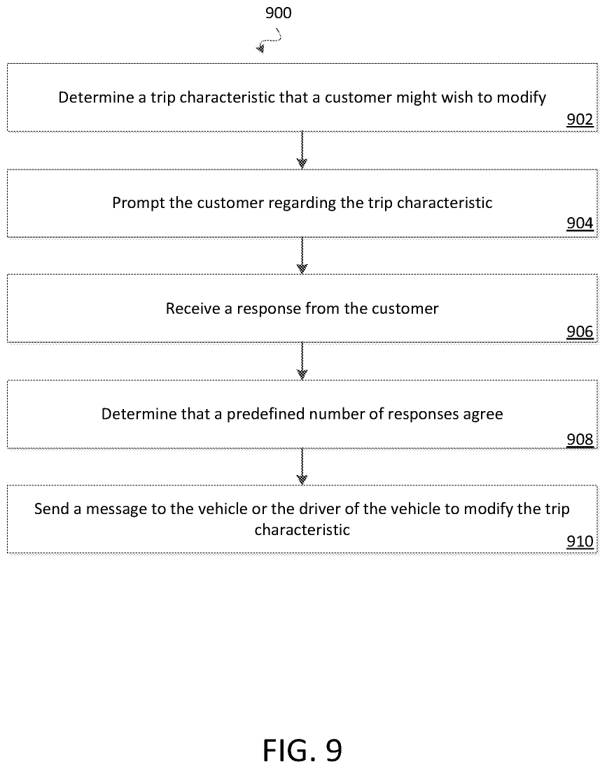

FIG. 9 illustrates an example method according to some embodiments. Example method 900 illustrates an example technique for modifying a trip characteristic in response to receiving a customer's response. A system can determine a trip characteristic that a customer might wish to modify 902. For example, the system can have a collection of trip characteristics that customers have different preferences about. Because of varying capabilities of different vehicles, certain characteristics can be available based on the vehicle that a customer is in. In some embodiments, the system can determine that a person might wish to modify a trip characteristic only after a certain condition is met or an environmental state has changed. For example, a customer might appreciate having the windows down when a vehicle is driving slowly but at higher speeds, the customer might wish to close the windows to mitigate the noise and wind. Another example includes the listening to the radio, a customer might appreciate listening to the radio, but if there is a gentle thunderstorm, the customer may prefer to stop the radio and listen to the rain Similarly, if a vehicle is fitted with windows that can be darkened or covered, the system can determine that a customer might wish to change the status of the windows based on whether the sun is out, whether there is a nice view, etc. In some embodiments, a customer may appreciate a certain characteristic for a time, but may wish to change the characteristic after an amount of time has passed. For example, when the journey begins the customer might like having interior lights on but later might appreciate having the lights turned off.

Trip characteristics can include a window status such as whether the window is open or closed, whether a window is tinted or clear, whether the window is covered or uncovered, etc. The trip characteristic need not be binary, for example a window can be partially open or partially tinted. Trip characteristics can include an audio function. For example, if there is a stereo or other loudspeaker configuration in the vehicle, the trip characteristics can include the volume of the audio, a station, song, playlist, genre, filters (e.g., to filter out material that some mind find offensive), equalizer setting (e.g., a bass or treble), etc. If there are one or more screens in the vehicle, a trip characteristic can be related to a screen brightness level, a program genre (e.g., action, documentary, news, educational, sports, etc.), a program content rating (e.g., an MPAA rating or similar content rating indicating whether the content is appropriate for certain people). A trip characteristic can apply to ostensibly private items; for example, a trip characteristic can limit the maximum volume for headsets or brightness of screens Similarly a trip characteristic can put limitations on media such that a person does not watch a program that other passengers might find offensive.

A trip characteristic can pertain to whether riders can recline their seats or not. For example, if all riders agree, then they may be permitted to recline their seats (e.g., manually or automatically). A physical mechanism can permit or prevent adjustment to the seats, alternatively a display can indicate whether or not adjustments to the seats are permissible and people can manually comply.

A trip characteristic can pertain to the route that the vehicle takes. For example, a trip characteristic can be a number, duration, or quality of stops that a vehicle makes. For example a vehicle may be able to stop for a bathroom break or allow riders to purchase food. In some embodiments, trip characteristics can include a comfort level for a journey such as whether to take a route with more traffic and noise or a calmer route that may take longer. Similarly, certain routes might be bumpy. In some embodiments, a trip characteristic can pertain to a maximum speed of a vehicle. For example, if a road has significant curves then a customer may feel more comfortable if the vehicle goes at a slower speed.

As previously discussed, a system can determine a relevant trip characteristic based on a vehicle's location such as whether there are interesting views or sounds, safety, weather (e.g., sunny, cloudy, rainy), etc. The relevant trip characteristic can be determined and/or triggered based on the time of day, a travel time elapsed (e.g., after the first 30 minutes), a new passenger arriving in the vehicle, a passenger departing, a new road (e.g., entering a highway), a vehicle speed, altitude (e.g., for an airplane), etc.

A system can prompt the customer regarding the trip characteristic 904. For example, the system can send a message to an electronic device associated with the customer such as a seatback entertainment system or a portable electronic device. In some embodiments, the system can prompt multiple customers in order to determine a consensus among riders in a vehicle. In some embodiments, the system determines the most relevant trip characteristic to prompt. Alternatively, the system can determine a collection of relevant trip characteristics to prompt a customer about.

In some embodiments, a system can determine based on a profile that the respective customer would prefer certain trip characteristics. For example, the system would not need to prompt the customer if the system determined with sufficient confidence that the customer had a certain preference. In some embodiments, the system can determine certain attributes of a customer based on the customer's profile. The system can then match the customer's profile to other, similar, profiles and deduce preferences based on the preferences of the similar profiles. Other techniques of predicting preferences based on a group of profiles can be used as known in the art. In some embodiments, a machine learning technique can determine correlations between profile characteristics and preferences and can predict a customer's preferences based on the customer's profile and the correlations.

A system can receive a response from the customer 906. For example, the system can receive an electronic message from an electronic device associated with the customer. In some embodiments, the customer can provide a verbal response to a prompt. In some embodiments, multiple customers can respond to a prompt, resulting in multiple responses. In some embodiments, if a customer does not respond within a certain period of time, then a default response can apply (e.g., the current trip characteristic).

A system can determine that a predefined number of responses agree 908. For example, for certain trip characteristics, the change be ratified based on a certain number of votes. For some trip characteristics, if one customer responds a certain way, then the one response will be determinative of the outcome of the characteristic. For other trip characteristics, a plurality, majority, or unanimity is required to determine the trip characteristic. In some embodiments, if an insufficient number of responses are identical, then another round of “voting” can ensue with the number of possible responses restricted to those more popular ones. In some embodiments, a response can include multiple values. For example, a response might detail the types of music that a passenger likes; the system can then determine a consensus amongst responses and select the types of music that are liked by a sufficient number of people.

A system can determine an optimal trip characteristic based on multiples responses from multiple people in a variety of ways. For example, if each passenger submits their food preferences, the system can determine an optimal stopping location that will have something nearby for each passenger. In some embodiments, each passenger can submit their favorite genres, songs, artists, etc. and the system can create a customized playlist of songs that will satisfy the passengers.

A system can send a message to the vehicle or the driver of the vehicle to modify the trip characteristic 910. For example, the system can automatically play music, run a movie, set a temperature, open windows, etc. If the trip characteristic is a route change (e.g., to go on a detour or to make a stop) a navigation system can alert a driver of the vehicle to make such a change. If the vehicle is not driver-operated such changes can be made automatically (e.g., if the vehicle is a train car then the rails can be switched accordingly). In some embodiments, an electronic device can instruct the driver to modify the trip characteristic. For example, an earpiece can convey an audio instruction to turn up the radio, drive slower, etc.

In some embodiments, a message can be sent to another passenger to modify the trip characteristic. For example, if the passengers agree through their respective prompts, to turn off video screens, then they can receive messages confirming that they should dim or turn off their video screens.

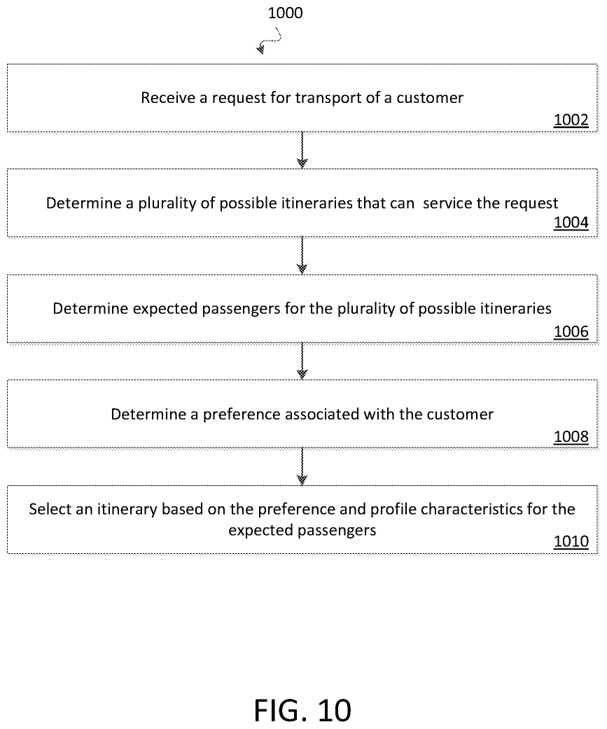

FIG. 10 illustrates an example method 1000 for aligning passenger preferences according to some embodiments. A system can receive a request for transport of a customer 1002. For example, the customer or an agent acting on behalf of the customer can request that a transportation service bring the customer from an origin to a destination at a certain time.

A system can determine a plurality of possible itineraries that can service the request 1004. For example, an itinerary can include one or more segments. Each segment can be a different mode of transportation (e.g., walk, bike, car, taxi, train, bus, airplane, etc.) of which one or more can be offered by the transportation service that determines the itineraries. An itinerary can specify a transfer between vehicles at certain times. In some embodiments, an itinerary is a predetermined plan, alternatively or additionally an itinerary can be created or adjusted to accommodate the request.

A system can determine expected passengers for the plurality of possible itineraries 1006. For example, certain passengers may have already booked transportation and may have a reserved place on certain vehicles. A passenger may already be in a vehicle used in one of the itineraries. It should be understood that passengers might be associated with a transfer location of an itinerary (e.g., a layover) even if they do not actually ride in a vehicle of the itinerary.

A system can determine a preference associated with the customer 1008. For example, the system can prompt the customer inquiring as to whether the customer has a preference to some trip characteristic. The trip characteristic can be one of the trip characteristics as described above. In some embodiments, the trip characteristic pertains to the preferences of the possible companions (e.g., the expected passengers). The system can use these preferences to match customers with riders that will likely have the same preferences related to the trip experience. In some embodiments, the customer has already begun a portion of their trip but the remainder of the itinerary modifiable or not yet determined.

A system can select an itinerary based on the preference and profile characteristics for the expected passengers 1010. For example, if the preference is that the customer wishes to not be in a vehicle with children, the system can determine an itinerary that does not include vehicles with children. The itinerary can be selected based how well the preference matches the preferences or other profile characteristics of the expected passengers. For example, the preference can be for a media preference (e.g., listening to music or watching a movie), an environmental preference (e.g., windows open or closed, temperature, lighting settings, etc.), and detour preferences (e.g., stopping to get food, etc.). In some embodiments, the preference can be to be in a vehicle where food is not allowed.

If the preference is that the customer wishes for a social environment while travelling, then an itinerary can be chosen based on whether the itinerary includes other similarly socially inclined individuals. In some embodiments, the preference can be for a certain affiliation; for example, the customer may be going to a sports game and wishes to be with fans of the same team.

In some embodiments, the system can perform an individual matchmaking service. For example, the system can determine which passengers would be interested in getting to know each other and put them on a same vehicle. Such matchmaking can business focused to provide customers with networking opportunities. For example, two people can be matched because they are in the same or complimentary fields. In some embodiments, a customer can have a preference for being with people in the same company (e.g., while commuting to work) such that the customer can work on or discuss confidential material. In some embodiments, the system can perform a romantic matchmaking service and connect two people based on their romantic preferences. Such matchmaking can provide a safe and quick way to get to know potential romantic interests.

It should be understood that the preference can be determined mid-trip and the remainder of the itinerary can be determined based on the preference.

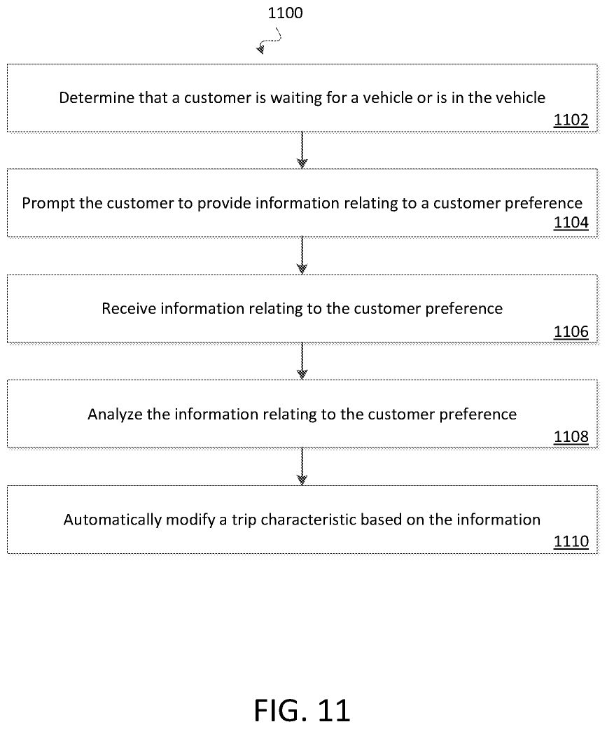

FIG. 11 illustrates an example method 1100 for automatically adjusting a trip characteristic according to various embodiments. A system such as a transit service can determine that a customer is waiting for a vehicle or is in the vehicle 1102. For example, the system can receive a message from a personal electronic device associated with the customer indicating a location of the customer (e.g., using a GPS on the electronic device). The system can determine that the location is near a location for the vehicle that is associated with the customer. The system can determine that the customer's location is at a pickup location (e.g., a bus stop or train station) where the customer is expected to board the vehicle. In some embodiments, the customer can indicate that they are ready to board the vehicle such as by sending a message or selecting an element. In some embodiments, the system can determine that the customer is in the vehicle based on the customer “checking in” at the vehicle. Detecting the customer checking in can be accomplished by determining that the customer has scanned a ticket, bar code, or similar at the vehicle. Detecting the customer checking in can be accomplished by determining that the customer has connected to a wireless device associated with the vehicle. In some embodiments, the system can determine that the customer is in the vehicle based on the customer interacting with an electronic device in the vehicle (e.g., a device associated with a seat assigned to the customer).

The system can prompt the customer to provide information relating to a customer preference 1104. For example, the system can send a push notification to a portable electronic device associated with the customer. In some embodiments, the system can first determine that an electronic device associated with the customer is not being actively utilized by the customer. For example, the device can be turned on by the customer but is kept at a “trip status” screen while withholding displaying of prompts. However, the system may allow sending of items such as a text message or an email via a third-party messaging platform at this time.

The customer preference can be for whether the customer prefers the windows open or closed, the air conditioner on, a preferred temperature, a preferred air velocity (e.g., how hard to blow a fan for internal air), a music or other audio station, a music genre, a musician, an audio volume, etc. The customer preference can pertain to whether the customer prefers that talking on a cell phone is allowed in the vehicle, that passengers talk amongst themselves in the vehicle, etc. The customer preference can pertain to a setting for lights in the vehicle, a seating configuration in the vehicle (e.g., whether the seats are reclined), a seating assignment in the vehicle (e.g., window seat), etc. the customer preference can pertain to food choices, such as the cost of food, the type (e.g., Italian, Chinese, American, etc.), the speed of the food, the ambiance of the food, how much of a detour the food would be, whether the food has alternative diet options (e.g., vegan, gluten-free, organic), etc. The customer preference can pertain to a driving style. For example, the customer might prefer that a driver change lanes repeatedly and drive more “aggressively” so as to save time. Alternatively the customer might prefer that the driver drive more casually to provide a more comfortable experience. The customer preferences can pertain to a level of safety or security that the customer prefers, such as wishing to avoid different parts of town or requiring a vehicle with tinted windows.

The system can receive information relating to the customer preference 1106. For example, the customer can send a text message or reply to a prompt on an electronic device. In some embodiments, the system can save the information relating to the customer preference in a customer profile. For example, the system can have a customer profile and can update the profile based on the customer preferences. In some embodiments, certain customer preferences can override customer profile elements set by previous customer preferences. For example, the customer might typically prefer having music playing and the system plays music while the customer is in the car; however, for a specific trip the customer can represent a preference for not having music. This can override the default preference and influence the profile to, in time, change the default preference.

The system can analyze the information relating to the customer preference 1108. For example, the customer preference might indicate that the customer prefers the windows open but the current vehicle does not have windows that can open. The system can then determine that the customer likely enjoys outside air. The system can then determine to bring in outside air into the vehicle. The system can analyze the information relating to the customer preferences along with information relating to customer preferences for other customers assigned to the same vehicle and/or in the vehicle.

The system can automatically modify a trip characteristic based on the information. For example, a vehicle routing system that routes vehicles and assigns customers to vehicles can modify the trip characteristic. This modification can be without human intervention. For example, the system can automatically instruct a vehicle to make certain modifications or can modify objects to change a vehicle's route (e.g., switches in a track). In some embodiments, the system can send an instruction to an operator of a vehicle to make a modification.

In some embodiments, the trip characteristic can include a routing characteristic. For example, the system can determine that all of the customers wish to stop for coffee. The system can then find an agreeable coffee shop that is a small detour from the current route. If not everyone wishes to stop, the system can determine a portion of the route wherein only people wishing to stop are still in the vehicle. The system can then determine a detour along that portion. In some embodiments, the system can modify a destination to better suit customer preferences. For example, if the destination is a mall and a customer prefers to eat, the system can drop off the customer at a side of the mall with a food court.

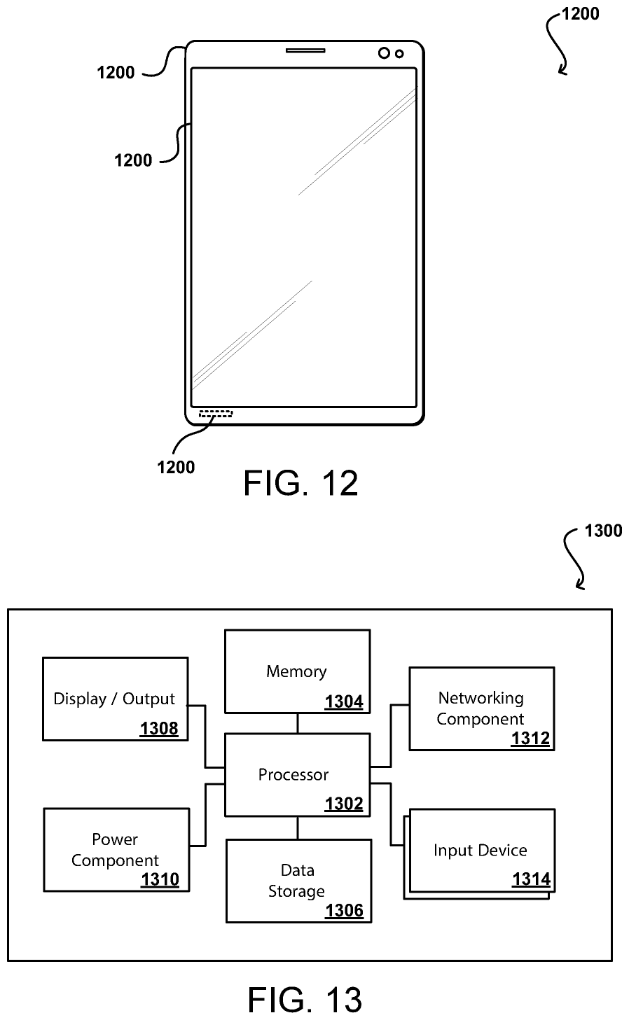

FIG. 12 illustrates an example computing device 1200 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1200 has an outer casing 1202 covering the various internal components, and a display screen 1204 such as a touch screen capable of receiving user input during operation of the device. These can be additional display or output components as well, and not all computing devices will include display screens as known in the art. The device can include one or more networking or communication components 1206, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 13 illustrates an example set of components 1300 that can comprise a computing device such as the computing device 1200 described above with respect to FIG. 12, as well as computing devices for other purposes such as application servers and data servers. The illustrated example device includes at least one main processor 1302 for executing instructions stored in physical memory 1304 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1306 for the device. Application instructions for execution by the at least one processor 1302 can be stored by the data storage 1306 then loaded into memory 1304 as needed for operation of the device 1300. The processor can also have internal memory in some embodiments for temporarily storing data and instructions for processing. The device can also support removable memory useful for sharing information with other devices. The device will also include one or more power components 1310 for powering the device. The power components can include, for example, a battery compartment for powering the device using a rechargeable battery, an internal power supply, or a port for receiving external power, among other such options.

The computing device may include, or be in communication with, at least one type of display element 1308, such as a touch screen, organic light emitting diode (OLED), or liquid crystal display (LCD). Some devices may include multiple display elements, as may also include LEDs, projectors, and the like. The device can include at least one communication or networking component 1312, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1314 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
receiving a transportation request from a customer to travel from a first location to a second location;
identifying a type of vehicle to service at least a portion of the transportation request;
assigning a first vehicle based on identifying the type of vehicle;
determining that the customer is one of waiting for the first vehicle or is in the first vehicle;
prompting the customer to provide information relating to one or more customer preferences;
receiving information relating to the one or more customer preferences;
analyzing the information relating to the one or more customer preferences; and
modifying a trip characteristic based on the information.

2. The computer-implemented method of claim 1, wherein the first vehicle is one of a passenger vehicle, a bus, or a train, and wherein modifying the trip characteristic includes automatically adjusting a vehicle routing system.

3. The computer-implemented method of claim 1, wherein modifying the trip characteristic comprises at least one of playing a song in the first vehicle, adjusting a volume of audio in the first vehicle, adjusting an air temperature in the first vehicle, adjusting an air velocity in the first vehicle, adjusting a window configuration of the first vehicle, adjusting a seat assignment of the first vehicle, or adjusting a seat configuration of the first vehicle.

4. The computer-implemented method of claim 1, wherein the first vehicle is a rideshare vehicle, and further comprising:
receiving customer preference information for one or more other customers assigned to the rideshare vehicle;
determining a consensus based on the customer preference information for the one or more other customers; and
further modifying the trip characteristic of the rideshare vehicle based on the consensus.

5. The computer-implemented method of claim 1, further comprising:
updating a first customer profile for the customer based on the one or more customer preferences;
obtaining a second customer profile associated with a second customer;
determining a match between the first customer profile and the second customer profile; and
assigning the second customer to the first vehicle based on the match.

6. The computer-implemented method of claim 1, further comprising:
determining, that an electronic device associated with the customer is not being actively utilized by the customer.

7. The computer-implemented method of claim 1, further comprising:
updating a profile for the customer based on the one or more customer preferences; and
using the profile to modify the trip characteristic before the customer enters the first vehicle.

8. A computer-implemented method, comprising:
receiving a transportation request from a customer to travel from a first location to a second location;
prompting the customer to provide information relating to one or more customer preferences;
receiving information relating to a first customer preference that is applicable to the customer over a first period of time during a trip;
analyzing the information relating to the first customer preference; and
modifying a trip characteristic of a vehicle over the first period of time based at least in part upon the first customer preference.

9. The computer-implemented method of claim 8, wherein modifying the trip characteristic includes automatically modifying a vehicle routing system.

10. The computer-implemented method of claim 8, wherein modifying the trip characteristic comprises at least one of playing a song in the vehicle, adjusting a volume of audio in the vehicle, adjusting an air temperature in the vehicle, adjusting an air velocity in the vehicle, adjusting a window configuration of the vehicle, changing a route of the vehicle, adding a stop for a route of the vehicle, adjusting a seat assignment of the vehicle, or adjusting a seat configuration of the vehicle.

11. The computer-implemented method of claim 8, further comprising:
receiving information relating to a second customer preference that is applicable to the customer over a second period of time during a trip;
analyzing the information relating to the second customer preference; and
further modifying the trip characteristic over the second period of time based at least in part upon the second customer preference.

12. The computer-implemented method of claim 11, wherein further modifying the trip characteristic over the second period of time comprises activating one or more lights of the vehicle.

13. The computer-implemented method of claim 8, further comprising:
determining that an electronic device associated with the customer is not being actively utilized by the customer.

14. The computer-implemented method of claim 13, further comprising:
displaying a trip status screen on the electronic device that is not being actively utilized by the customer; and
withholding displaying of prompts on the electronic device that is not being actively utilized by the customer.

15. A system, comprising:
a computer having a memory that stores computer-executable instructions and a processor configured to access the memory and execute the computer-executable instructions to at least:
receive a transportation request from a customer to travel from a first location to a second location;
identify a type of vehicle to service at least a portion of the transportation request;
assign a first vehicle based on the identifying the type of vehicle;
determine that the customer is one of waiting for the first vehicle or is in the first vehicle;
prompt the customer to provide information relating to one or more customer preferences;
receive information relating to the one or more customer preferences;
analyze the information relating to the one or more customer preferences; and
modify a trip characteristic based on the information.

16. The system of claim 15, wherein the first vehicle is one of a passenger vehicle, a bus, or a train, and wherein modifying the trip characteristic includes automatically adjusting a vehicle routing system.

17. The system of claim 15, wherein modifying the trip characteristic comprises at least one of playing a song in the first vehicle, adjusting a volume of audio in the first vehicle, adjusting an air temperature in the first vehicle, adjusting an air velocity in the first vehicle, adjust a window configuration of the first vehicle, changing a route of the first vehicle, adding a stop for a route of the first vehicle, adjusting a seat assignment of the first vehicle, or adjusting a seat configuration of the first vehicle.

18. The system of claim 15, wherein the first vehicle is a rideshare vehicle, and wherein the processor is further configured to access the memory and execute the computer-executable instructions to at least:
receive one or more responses from one or more other customers in the rideshare vehicle; and
further modify the trip characteristic based on the one or more responses.

19. The system of claim 15, wherein the first vehicle is a rideshare vehicle, and wherein the processor is further configured to access the memory and execute the computer-executable instructions to at least:
receive customer preference information for one or more other customers assigned to the rideshare vehicle;
determine a consensus based on the customer preference information for the one or more other customers; and
further modify the trip characteristic based on the consensus.

20. The system of claim 15, wherein the processor is further configured to access the memory and execute the computer-executable instructions to at least:
update a profile for the customer based on the information; and
modify a vehicle characteristic before the customer enters the vehicle, based on the profile.
